(19) United States
(12) Patent Application Publication
(10) Pub. No.: US 2003/0198492 A1
(43) Pub. Date: Oct. 23, 2003

(54) Image forming apparatus comprising a transfer device applying methods of belt conveying and contact transferring

(75) Inventor: Sunao Takenaka, Yokohama-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/418,152

(22) Filed: Apr. 18, 2003

(30) Foreign Application Priority Data
Apr. 23, 2002 (JP) 2002-120766

(51) Int. Cl. G03G 15/16

(52) U.S. Cl. 399/312; 399/313

(57) ABSTRACT

An image forming apparatus includes a photosensitive member which is provided on an outer surface of a drum that rotates and on which a toner image is formed, and a belt which contacts a recording sheet with a photosensitive member while conveying the recording sheet, to transfer a toner image formed on the outer surface of the photosensitive member to the recording sheet. The photosensitive member and the transferring belt are rotated so that the time required for an arbitrary point on the photosensitive member and an arbitrary point on the transferring belt to pass through a nip area that electrically connects the photosensitive member and the transferring belt together is 20 msec or more.

### CROSS-REFERENCE TO RELATED APPLICATIONS

This application is based upon and claims the benefit of priority from the prior Japanese Patent Application No. 2002-120766, filed Apr. 23, 2002, the entire contents of which are incorporated herein by reference.

### BACKGROUND OF THE INVENTION

1. Field of the Invention

The present invention relates to an image forming apparatus on which a transferring device based on the method of belt conveying and contact transferring is mounted.

2. Description of the Related Art

An image forming apparatus such as a printer is known which employs electrophotography. The image forming apparatus comprises a transferring device that transfers a toner image formed on a photosensitive member to a recording sheet. One form of a transferring device employs the method of belt conveying and contact transferring which comprises conveying the recording sheet using a belt, and during the conveyance, contacting the recording sheet with the photosensitive member to transfer the toner image formed on the surface of the photosensitive member to the recording sheet.

This transferring device comprises a transferring belt that uses a member having a volume resistivity between 1×10⁶ to 1×10¹² Ω·cm, a plurality of supporting rollers that rotatably support the transferring belt, and a transferring bias roller that contacts with the transferring belt to apply a bias voltage to it. As the bias voltage is applied between the transferring belt and the photosensitive member, the toner image is transferred from the photosensitive member to the recording sheet.

In Jpn. Pat. Appln. KOKAI Publication No. 02-110586, the transferring bias roller contacts with the transferring belt downstream of the contact area between the transferring belt and the photosensitive member in a direction in which the recording sheet is conveyed. The supporting roller is grounded which supports the transferring belt upstream of the contact area between the transferring belt and the photosensitive member in the direction in which the recording sheet is conveyed. The transferring belt is provided with a potential gradient exhibiting a lower potential on an upstream side of the transferring belt and a higher potential on its downstream side in the direction in which the recording sheet is conveyed. This prevents toner from scattering from the photosensitive member toward the transferring belt, upstream of the area in which the recording sheet is sandwiched between the transferring belt and the photosensitive member. The quality of the toner image transferred to the recording sheet is thus hindered from being degraded. However, conductive failure may occur due to aged deterioration resulting from vibration or wear, at the contact point at which the supporting roller is grounded to provide the potential gradient is likely to become. This failure will degrade the quality of the toner image.

Further, if the recording sheet contains a large amount of moisture because of a humid environment, some electric charges of the transferring bias voltage applied to the transferring belt flow through the wet recording sheet to the grounded supporting rollers, located on the upstream side of the transferring belt. A current is thus generated. As a result, the transferring belt is not sufficiently charged, thus causing the toner image to be improperly transferred. Consequently, the quality of the toner image is degraded.

To solve this problem, Harasawa et al. have disclosed, in Jpn. Pat. Appln. KOKAI Publication No. 06-167896, a method of providing a potential difference leading to a potential gradient between the transferring bias roller and the supporting rollers without grounding the upstream supporting roller, to prevent the generation of an unwanted current.

However, the long continuous use of the transferring device may electrically charge the supporting rollers to gradually decrease the potential difference between the transferring bias roller and the supporting rollers. The recording sheet is charged before coming into contact with the photosensitive member. Accordingly, the recording sheet may (electrostatically) attract part of the toner on the photosensitive member or may charge the toner to the same potential as that on the recording sheet in a pre-transfer area located immediately before the area in which the recording sheet comes into contact with the photosensitive member. As a result, the quality of the toner image transferred to the recording sheet is degraded. The toner image with the degraded quality may be as described below. For example, the toner attracted to the charged recording sheet in the pre-transfer area forms so-called “image spattering” that obscures the image with a fine dot formed by the toner scattered around the contour of the toner image. Further, the toner charged with the same potential as that on the recording sheet forms so-called “transfer pockmarks” that blurs the toner image by being conversely moved the toner attracted to the photosensitive member from the recording sheet.

### BRIEF SUMMARY OF THE INVENTION

An image forming apparatus of an embodiment according to the present invention comprises a photosensitive member which is rotatably provided and on which a toner image is formed and a belt which contacts a recording sheet with a photosensitive member while conveying the recording sheet, to transfer a toner image formed on an outer surface of the photosensitive member to the recording sheet. The recording sheet remains sandwiched between an arbitrary point on the photosensitive member and an arbitrary point on the transferring belt for 20 msec or more.

Objects and advantages of the invention will become apparent from the description which follows, or may be learned by practice of the invention.

### BRIEF DESCRIPTION OF THE DRAWINGS

The accompanying drawings illustrate embodiments of the invention, and together with the general description given above and the detailed description given below, serve to explain the principles of the invention.

FIG. 1 is a view schematically showing an image forming apparatus of an embodiment according to the present invention;

FIG. 2 is a diagram showing the distribution of electric potentials on the transferring belt shown in FIG. 1;

FIG. 3 is a diagram showing the relationship between the time required for a portion on the outer peripheral surface of the photosensitive drum shown in FIG. 1 to pass through a nip area and the incidence of “image spattering” on a toner image formed on a recording sheet;

FIG. 4 is a diagram showing the range within which discharge occurs in connection with the relationship between a gap A, shown in FIG. 1, and a bias voltage for transferring; and

FIG. 5 is a diagram showing the range within which discharge occurs in connection with the relationship between a gap B, shown in FIG. 1, and a bias voltage for transferring.

### DETAILED DESCRIPTION OF THE INVENTION

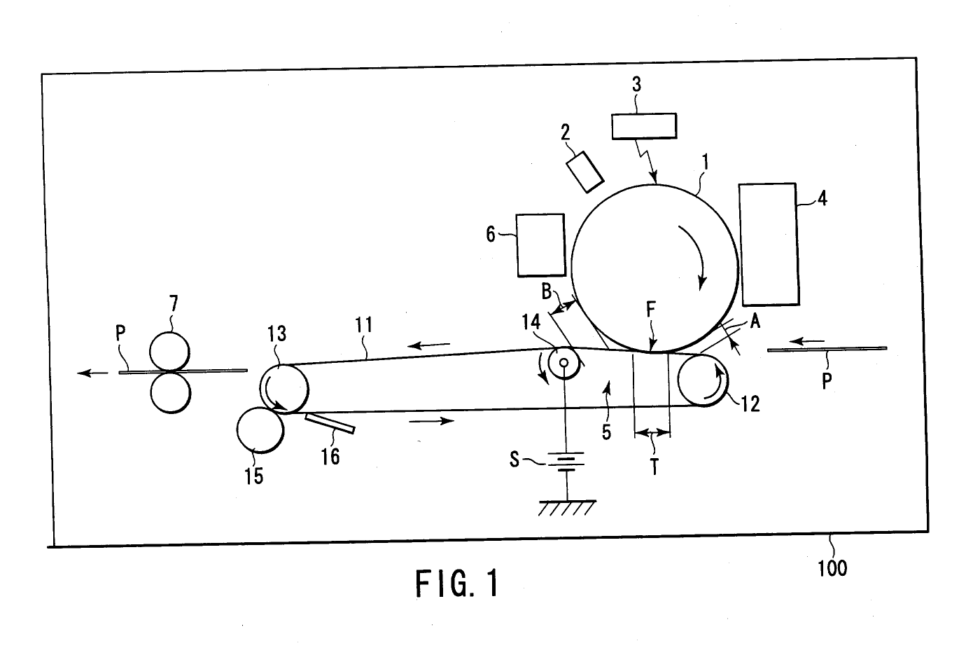

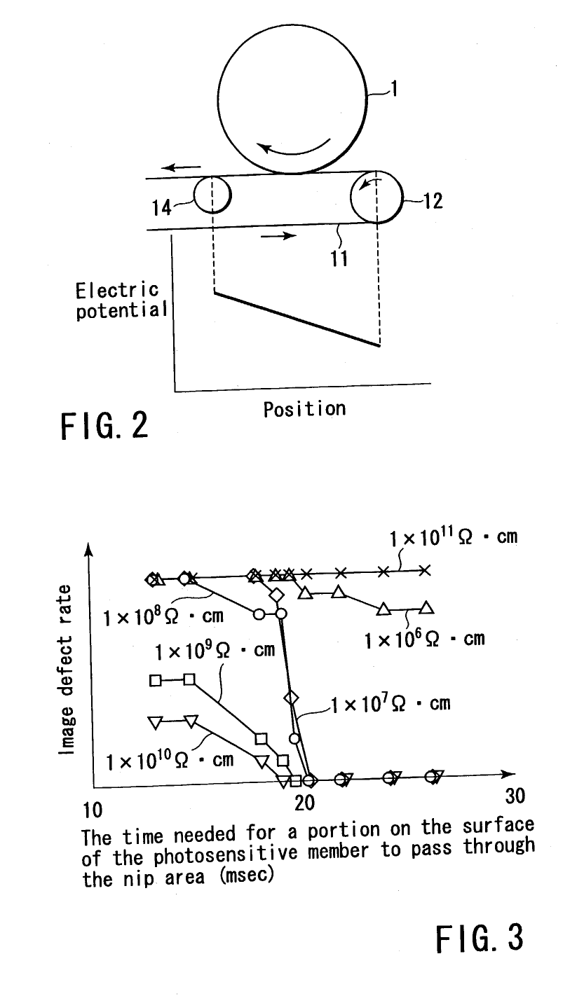

An image forming apparatus 100 of an embodiment according to the present invention will be described with reference to FIGS. 1 to 5. The image forming apparatus 100 comprises a photosensitive drum 1, a charging device 2, an exposing device 3, a developing device 4, a transferring device 5, a cleaning device 6, and a fixing device 7. The photosensitive drum 1 is an example of a photosensitive member and is arranged in the image forming apparatus 100 so as to extend in its lateral direction. The photosensitive drum 1 is rotated by a driving device in the direction of an arrow in FIG. 1. The charging device 2, the exposing device 3, the developing device 4, the transferring device 5, and the cleaning device 6 are arranged around the photosensitive drum 1 in this order along the direction in which the photosensitive drum 1 is rotated. Further, the fixing device 7 is provided downstream of the transferring device 5 in the direction in which a recording sheet P is conveyed.

The charging device 2 charges the outer peripheral surface of the photosensitive drum 1. The exposure device 3 exposes the peripheral surface of the photosensitive drum 1 to form an electrostatic latent image on this surface. The developing device 4 supplies toner to the peripheral surface of the photosensitive drum 1. The toner is attracted to the electrostatic latent image, forming a visible image, known as “toner image.” The transferring device 5 transfers the toner image formed on the peripheral surface of the photosensitive drum 1 to the recording sheet P. The details of the transferring device 5 will be described later. The cleaning device 6 removes toner remaining on the peripheral surface of the photosensitive drum 1 after transfer. The fixing device 7 fixes the toner image transferred to the recording sheet P.

The transferring device 5 will be described. The transferring device 5 employs the method of belt conveying and contact transferring which comprises contacting the recording sheet P with the peripheral surface of the photosensitive member 1 while conveying the recording sheet P using a transferring belt 11, to transfer the toner image from the photosensitive drum 1 to the recording sheet P. In the image forming apparatus 100 of this embodiment, the transferring device 5 is arranged below the photosensitive drum 1. The transferring device 5 comprises the transferring belt 11, supporting rollers 12 and 13, a transferring bias roller 14, a fur brush 15, and a cleaning blade 16.

The transferring belt 11 is formed to be endless and has a width corresponding to the roll width of the photosensitive drum 1. The transferring belt 11 is formed of a member having a volume resistivity between 1×10⁷ to 1×10¹⁰ Ω·cm, e.g. CR (chloroprene) based rubber containing carbon. The recording sheet P is loaded onto a first half of the transferring belt 11 and conveyed from the right to left of FIG. 1.

The supporting rollers 12 and 13 are arranged parallel with the photosensitive drum 1 to rotatably support the inner peripheral surface of the transferring belt 11 so that the belt 11 can be rotated. One 12 of the supporting rollers is a follower roller arranged upstream of the photosensitive drum 1 in the direction in which the recording sheet P is conveyed. The other supporting roller 13 connects to a rotational driving device and is arranged downstream of the photosensitive drum 1. The supporting roller 13 is rotated by the rotational driving device in the direction of an arrow in FIG. 1. In union with this rotation, the transferring belt 11 circulates in the direction an arrow in FIG. 1. The circulation of the transferring belt 11 rotates the supporting roller 12 in the direction of an arrow in FIG. 1. Further, the supporting roller 12 is not grounded but is electrically floating.

The first half of the transferring belt 11 extends from the supporting roller 12 to the supporting roller 13 in the circulating direction (the upper part of the arrangement). The second half of the transferring belt 11 extends from the supporting roller 13 to the supporting roller 12 in the circulating direction (the lower part of the arrangement). The first half of the transferring belt 11 partly contacts with the peripheral surface of the photosensitive drum 1 from below. The transferring belt 11 and the photosensitive drum 1 are electrically connected together in a contact area (nip area) F in which they contact with each other. Further, even if the recording sheet P is conveyed, the transferring belt 1 is electrically connected to the photosensitive drum 1 via the recording sheet P in the contact area (nip area) F. The supporting roller 12 is an example of a supporting member that supports a portion of the transferring belt 11 which is located upstream of the contact area F in the direction in which the recording sheet P is conveyed. The contact area F is located between the supporting rollers 12 and 13 and closer to the supporting roller 12 in the direction in which the recording sheet P is conveyed. This is because this arrangement serves to easily stabilize the contact pressure between the photosensitive drum 1 and the transferring belt 11.

The transferring bias roller 14 is arranged inside the circulating transferring belt 11, i.e. between the supporting rollers 12 and 13 parallel with the photosensitive drum 1. The transferring bias roller 14 is an example of a transferring bias electrode that contacts with the upper inner peripheral surface of upper part (first half) of the transferring belt 11 to apply a transferring bias voltage between itself and the photosensitive drum 1 via the transferring belt 11. The transferring bias roller 14 is connected to a DC power supply S. Since the transferring belt 11 has a volume resistivity between 1×10⁷ and 1×10¹⁰ Ω·cm, the transferring bias voltage applied by the transferring bias roller 14 causes a small current to flow to the photosensitive drum 1.

The contact position between the transferring bias roller 14 and the transferring belt 11 is provided downstream of the contact area F between the photosensitive drum 1 and the transferring belt 11 in the circulating direction of the transferring belt 11. Further, the transferring bias roller 14 is arranged closer to the photosensitive drum 1 than to the supporting roller 13. This arrangement allows a current to flow more easily from the transferring bias roller 14 to the photosensitive drum 1.

The peripheral surface of the photosensitive drum 1 contacts with the first half of the transferring belt 11, between the supporting roller 12 and the transferring bias roller 14. To appropriately contact the outer peripheral surface of the transferring belt 11 with the peripheral surface of the photosensitive drum 1, one or both of the supporting roller 12 and transferring bias roller 14 are attached to an adjusting mechanism. The adjusting mechanism moves the supporting roller 12 or the transferring bias roller 14 in the direction in which it approaches or leaves the photosensitive drum 1. The adjusting mechanism comprises an elastic member like a spring to apply force to the supporting roller 12 or the transferring bias roller 14 toward the photosensitive drum 1. The adjusting mechanism moves the supporting roller 12 and the transferring bias roller 14 toward the photosensitive drum 1, thus applying tension to the transferring belt 11. As the result, the photosensitive side of both the supporting roller 12 and the transferring bias roller 14 lie in a plane that intersects with the outer surface of the photosensitive drum 1. Hence, the outer peripheral surface of the transferring belt 11 stays in stable contact with the peripheral surface of the photosensitive drum 1.

The fur brush 15 and the cleaning blade 16 are provided on the outer surface of the transferring belt 11 in its area located downstream of the contact position between the transferring belt 11 and the transferring bias roller 14 in the direction in which the recording sheet P is conveyed, e.g. a portion of the transferring belt 11 which is supported by the supporting roller 13 as a driving roller.

In this image forming apparatus 100, the photosensitive drum 1 and the transferring belt 11 are rotated so that the time required for an arbitrary point on the peripheral surface of the photosensitive drum 1 to pass through the contact area (nip area) F is 20 msec or more, i.e. the arbitrary point on the peripheral surface of the photosensitive drum 1 keeps in contact with the transferring belt 11 for 20 msec or more, or the arbitrary point on the peripheral surface of the photosensitive drum 1 keeps in contact with the recording sheet P for 20 msec or more, or the recording sheet P remains sandwiched between arbitrary points of the photosensitive drum 1 and transferring belt 11 for 20 msec or more. This time is preferably set at a value between 20 and 26 msec. By thus setting the time required for the contact between the photosensitive drum 1 and the transferring belt 11, the charges on the transferring bias roller 14 flow into the photosensitive drum 1 via the transferring belt 11. Thus, only a practically negligible amount of current flows into the supporting roller 12. As a result, although the recording sheet P contacts with a portion of the transferring belt 11 which externally contacts with the supporting roller 12, it is scarcely charged before reaching the nip portion (contact area F) between the peripheral surface of the photosensitive drum 1 and the transferring belt 11. This hinders an electric field from being generated in the pre-transfer area located immediately before the nip area. The quality of the toner image transferred to the recording sheet P can therefore be prevented from being degraded by “image spattering.”

The time for which the photosensitive drum 1 and the transferring belt 11 keep in contact with each other is proportional to the speed at which the arbitrary point on the peripheral surface of the photosensitive drum 1 passes through the contact area F (nip area), i.e. the peripheral speed of the photosensitive drum 1, and the width T of the contact area F between the peripheral surface of the photosensitive drum 1 and the transferring belt 11 (the length of the contact area F along the conveying direction of the recording sheet P).

The peripheral speed of photosensitive drum 1 of the image forming apparatus 100 is set at a value between 418 and 422 mm/sec, preferably at 422 mm/sec so as to successfully transfer the toner image formed on the peripheral surface of the photosensitive drum 1 to the recording sheet P. The rotation speed of the photosensitive drum 1 is controlled to obtain this range of peripheral speed. The length T of the contact area F along the conveying direction of the recording sheet P is set at a value between 8.4 and 10.9 mm, preferably between 9.0 and 9.4 mm so as to successfully transfer the toner image formed on the peripheral surface of the photosensitive drum 1 to the recording sheet P. These ranges are attributed to the time for which the photosensitive drum 1 and the transferring belt 11 keep in contact with each other and the outer diameter of the photosensitive drum 1 with which the recording sheet P can be suitably separated from the photosensitive drum 1 (the curvature of outer surface of the photosensitive drum 1).

To set the length T of the contact area F, the adjusting mechanism is used to move the supporting roller 12 and the transferring bias roller 14 in the direction in which these rollers approach the photosensitive drum 1. This causes the supporting roller 12 and the transferring bias roller 14 to contact the transferring belt 11 with the peripheral surface of the photosensitive drum 1.

However, if the gap A between the peripheral surface of the photosensitive drum 1 and the supporting roller 12 is small (if the supporting roller 12 excessively approaches the peripheral surface of the photosensitive drum 1), then in an area preceding the one that is to undergo transfer (pre-transfer area), a high electric field develops between the photosensitive drum 1 and the recording sheet P to cause a discharge.

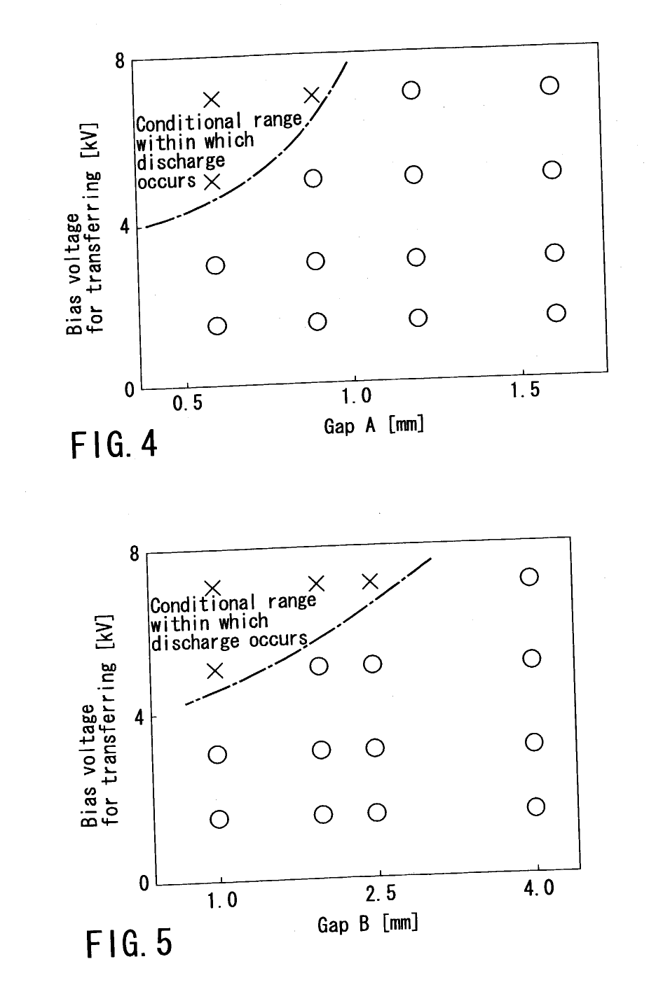

In the graph in FIG. 4, the axis of abscissa indicates the size of the gap A, and the axis of ordinate indicates the bias voltage for transferring. This graph shows the results of examination of the size of the gap A with which discharge occurs, the examination being carried out by varying the size of the gap A at each bias voltage for transferring. Tests were conducted in an environment with a temperature of 25° C. and a relative humidity of 50% RH. Further, a current flowing from the transferring bias roller 14 was set at a constant value of 80 μA. To set the current at the constant value, transferring belts 11 of different volume resistivities were used with the respective bias voltages for transferring. A transferring belt 11 of volume resistivity 1×10¹⁰ Ω·cm was used with a bias voltage for transferring of 7 kV. A transferring belt 11 of volume resistivity 1×10⁹ Ω·cm was used with a bias voltage for transferring of 5 kV. A transferring belt 11 of volume resistivity 1×10⁸ Ω·cm was used with a bias voltage for transferring of 3 kV. A transferring belt 11 of volume resistivity 1×10⁷ Ω·cm was used with a bias voltage for transferring of 1.5 kV.

FIG. 4 indicates that a discharge phenomenon occurs when the gap A is 0.7 mm or less in size at a bias voltage for transferring of 5 kV and when the gap A is less than 1.0 mm in size at a bias voltage for transferring of 7 kV. Further, at a bias voltage for transferring of 3 kV or lower, the discharge phenomenon does not occur even if the gap A is 0.5 mm or less in size. Consequently, at a bias voltage for transferring of 7 kV (if the transferring belt 11 has a volume resistivity of 1×10¹⁰ Ω·cm) or less, the size of the gap A should be set at 1.0 mm or more. At a bias voltage for transferring of 5 kV (if the transferring belt 11 has a volume resistivity of 1×10⁹ Ω·cm) or less, the size of the gap A should be set at 0.8 mm or more.

Further, a discharge phenomenon occurs between the photosensitive drum 1 and the transferring bias roller 14 when a gap B between the peripheral surface of the photosensitive drum 1 and the transferring bias roller 14 is small (when the transferring bias roller 14 excessively approaches the peripheral surface of the photosensitive drum 1).

In the graph in FIG. 5, the axis of abscissa indicates the size of the gap B, and the axis of ordinate indicates the bias voltage for transferring. This graph shows the results of examination of the size of the gap B with which discharge occurs at each bias voltage for transferring. Tests were conducted in the environment with a temperature of 25° C. and a relative humidity of 50% RH. Further, as in the case with FIG. 4, the current flowing from the transferring bias roller 14 was set at a constant value of 80 μA. To set the current at the constant value, transferring belts 11 of different volume resistivities were used with the respective bias voltages for transferring. A transferring belt 11 of volume resistivity 1×10¹⁰ Ω·cm was used with a bias voltage for transferring of 7 kV. A transferring belt 11 of volume resistivity 1×10⁹ Ω·cm was used with a bias voltage for transferring of 5 kV. A transferring belt 11 of volume resistivity 1×10⁸ Ω·cm was used with a bias voltage for transferring of 3 kV. A transferring belt 11 of volume resistivity 1×10⁷ Ω·cm was used with a bias voltage for transferring of 1.5 kV.

The graph in FIG. 5 indicates that a discharge phenomenon occurs when the gap B is smaller than 1.4 mm in size at a bias voltage for transferring of 5 kV and when the gap B is less than 2.8 mm in size at a bias voltage for transferring of 7 kV. Consequently, at a bias voltage for transferring of 7 kV (if the transferring belt has a volume resistivity of 1×10¹⁰ Ω·cm) or less, the size of the gap B should be set at 2.8 mm or more. At a bias voltage for transferring of 5 kV (if the transferring belt has a volume resistivity of 1×10⁹ Ω·cm) or lower, the size of the gap B should be set at 1.4 mm or more.

Now, operations of the transferring device 5 will be described. A power supply S applies a bias voltage to the transferring bias roller 14. The bias voltage has the polarity opposite to that of the toner forming a toner image on the recording sheet P. When each portion of the transferring belt 11 approaches the photosensitive drum 1 as the transferring belt 11 is driven, an electric charge is applied to the transferring belt 11 from the transferring bias roller 14. The recording sheet P is conveyed from the right of FIG. 1 and loaded onto the outer peripheral surface of upper part (first half) of the transferring belt 11. As the transferring belt 11 circulates, the recording sheet P is conveyed leftward and passes through the contact area (nip area) F between the first half of the transferring belt 11 and the peripheral surface of the photosensitive drum 1. In the contact area F, the toner image formed on the peripheral surface of the photosensitive drum 1 is transferred to the recording sheet P because the transferring belt 11 is charged at the polarity opposite to that of the toner.

Further, the recording sheet P is polarized by the charges applied to the transferring belt. Consequently, electrostatic attractive force is generated between these polarizing charges and the charges on the transferring belt 11. The recording sheet P is attracted to the transferring belt 11 owing to this electrostatic attractive force. Then, as the transferring belt 11 circulates, the recording sheet P is conveyed in the direction of an arrow in FIG. 1 (leftward) to the fixing device 7.

Toner remaining on the photosensitive drum 1 adheres to the surface (outer surface) of first half of the circulating transferring belt 11. This is because the photosensitive drum 1 and the transferring belt 11 keep in direct contact with each other after the last transfer has been completed and before the next recording sheet P is conveyed. The remaining toner is scraped off the surface of the transferring belt 11 by the fur brush 15 and the cleaning blade 16 when the transferring belt 11 is turned by the supporting roller 13 and then circulates along the second half.

The image forming apparatus 100 is designed so that the time required for an arbitrary point on the peripheral surface of the photosensitive drum 1 to pass through the contact area F between the peripheral surface and the transferring belt 11 (the time for which the arbitrary point on the photosensitive drum 1 and the arbitrary point on the transferring belt keep in contact with each other) is 20 msec or more, preferably 20 to 26 msec as previously described. FIG. 3 shows the relationship between the time required for the arbitrary point on the photosensitive drum 1 to pass through the contact area F and the incidences of “image spattering” and “transfer pockmarks” (the number of occurrences). If the volume resistivity of the transferring belt 11 is 1×10⁷ to 1×10¹⁰ Ω·cm, and if the time required for a given point on the peripheral surface of the photosensitive drum 1 to pass through the contact area F is between 20 and 26 msec, this setting prevents the degradation of the toner image transferred to the recording sheet P, e.g. prevents the situation in which the edge of the toner image appears like scattering fine particles to make the image unclear (image spattering) or in which the toner of the toner image transferred to the recording sheet P is conversely attracted to and thus moved onto the photosensitive drum 1, where it is dispersed (transfer pockmarks).

This is assumed to be because when the time for which the photosensitive drum 1 and the transferring belt 11 keep in contact with each other is set at the above value, the amount of electric charges flowing from the transferring bias roller 14 into the photosensitive drum 1 via the transferring belt 11 increases and the amount of electric charge (branch current) flowing into the supporting roller 12, which is located upstream of the photosensitive drum 1 in the direction in which the recording sheet P is conveyed, reduces down to a practically negligible level.

Thus, even if the supporting roller 12 is electrically floating rather than being grounded, the recording sheet P is prevented from being charged by the charges flowing to the supporting roller 12 before the sheet P reaches the contact area F between the peripheral surface of the photosensitive drum 1 and the transferring belt 11.

Further, when the sizes of the gap A between the photosensitive drum 1 and the supporting roller 12 and of the gap B between the photosensitive drum 1 and the transferring bias roller 14 are set at values within the previously described ranges, the discharge phenomenon can be prevented in these gaps A and B.

Thus, using the inexpensive means for appropriately adjusting the time required for the given point on the peripheral surface of the photosensitive drum 1 to pass through the contact section F, the quality of the toner image transferred to the recording sheet P can be prevented from being degraded even if the supporting roller 12 is not grounded but is electrically floating.

By thus increasing the time for which the given point on the photosensitive drum 1 keeps in indirect contact with the transferring belt 11 via the recording sheet P, the charges can be moved to the photosensitive drum 1 to reduce the amount of charges flowing into the supporting roller 12, down to a negligible level.

In the previous description of the embodiment, the supporting roller 12, located upstream of the photosensitive drum 1 in the direction in which the recording sheet P is conveyed, is not grounded but is electrically floating. Additionally, to eliminate the disadvantages of the grounded supporting roller 12, the supporting roller 12 can be effectively grounded via a high-resistance element that is similar to an insulator. Applying this method to the present invention provides operations and effects similar to those of the previously descried embodiments.

Further, if the present invention is implemented, the roller supporting the transferring belt 11 is not limited to the pair of supporting rollers 12 and 13. For example, a set of three or more rollers may be used. Furthermore, the transferring device 5 has only to comprise a supporting member that supports at least that portion of the transferring belt 11 which is located upstream of the contact area F between the transferring belt 11 and the photosensitive drum 1 in the direction in which the recording sheet P is conveyed. In this case, the supporting member is not limited to a roller but may be a device that supports the transferring belt 11 on the basis of sliding contact. The transferring bias roller 14 is an example of a transferring bias electrode and has only to contact with that portion of the transferring belt 11 which is located downstream of the contact area F between the transferring belt 11 and the photosensitive drum 1 in the direction in which the recording sheet P is conveyed, to apply a transferring bias voltage. Accordingly, the transferring bias electrode is not limited to the roller set in rolling contact with the transferring belt 11. It is may be a rod, a blade, or a bar that lies in sliding contact with the transferring belt.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the inventive as defined by the appended claims and equivalents thereof.

What is claimed is:

1. An image forming apparatus comprising:
a photosensitive member which is rotatably provided and on which a toner image is formed; and a transferring device having a transferring belt rotatably supported to convey a recording sheet while contacting the recording sheet with the photosensitive member, a transferring bias electrode which contacts with the transferring belt downstream of a contact area between the photosensitive member and the recording sheet in a direction in which the recording sheet is conveyed, to apply a transferring bias voltage to the transferring belt, and a supporting member which supports the transferring belt upstream of the contact area between the photosensitive member and the recording sheet in the direction in which the recording sheet is conveyed, the transferring device transferring the toner image formed on the photosensitive member to the recording sheet;
wherein the photosensitive member is rotated so that a time required for an arbitrary point on the photosensitive member to pass through a nip area that electrically connects the photosensitive member and the transferring belt together is 20 msec or more.

2. The image forming apparatus according to claim 1, wherein the photosensitive member is rotated so that the time required for an arbitrary point on the photosensitive member to pass through the nip area is between 20 and 26 msec.

3. The image forming apparatus according to claim 1, wherein the photosensitive member and the transferring belt sandwich the recording sheet having a length between 8.4 to 10.9 mm, in the direction of conveying the recording sheet.

4. The image forming apparatus according to claim 1, wherein the transferring belt has a volume resistivity between 1×10⁷ and 1×10¹⁰ Ω·cm.

5. An image forming apparatus comprising:
a photosensitive member which rotates and has a drum-shaped outer surface on which a toner image is formed; and
a transferring belt which conveys a recording sheet to contact the recording sheet with the photosensitive member in order to transfer the toner image formed on the outer surface of the photosensitive member to the recording sheet;
wherein the photosensitive member and the transferring belt are rotated so that a time required for an arbitrary point on the photosensitive member and an arbitrary point on the transferring belt to pass through a nip area which electrically connects the photosensitive member and the transferring belt together is between 20 and 26 msec.

6. The image forming apparatus according to claim 5, wherein the nip area has a length between 8.4 and 10.9 mm in a direction in which the recording sheet is conveyed.

7. The image forming apparatus according to claim 5, wherein the transferring belt is supported by supporting rollers at upstream and downstream of the nip area, respectively, in the direction in which the recording sheet is conveyed, and a transferring bias voltage is applied between the photosensitive member and the downstream supporting roller; and
at least the upstream supporting roller electrically floats.

8. An image forming apparatus comprising:
a photosensitive member which rotates and has a drum-shaped outer surface on which a toner image being formed; and
a transferring belt which conveys a recording sheet to contact the recording sheet with the photosensitive member in order to transfer the toner image formed on the outer surface of the photosensitive member to the recording sheet;
wherein the photosensitive member and the transferring belt are rotated so that the recording sheet conveyed to the transferring belt and an arbitrary point on the photosensitive member keep in contact with each other for 20 msec or more.
